(19) United States
(12) Patent Application Publication
(10) Pub. No.: US 2014/0188755 A1
(43) Pub. Date: Jul. 3, 2014

(54) SYSTEM AND METHOD FOR MANAGING MULTIPLE TRANSPORTATION AGREEMENTS

(71) Applicants: Maya Viswanath, Bangalore (IN); Saurabh Chaturvedi, Bangalore (IN); Premalatha Subramanian, Bangalore (IN)

(72) Inventors: Maya Viswanath, Bangalore (IN); Saurabh Chaturvedi, Bangalore (IN); Premalatha Subramanian, Bangalore (IN)

(73) Assignee: SAP AG, Walldorf (DE)

(21) Appl. No.: 13/729,940

(22) Filed: Dec. 28, 2012

(51) Int. Cl. G06Q 10/00

(52) U.S. Cl. CPC G06Q 10/00
USPC 705/342

(57) ABSTRACT

A system and method that stores a plurality of transportation agreements, associates a plurality of data objects and sub-objects with each of the plurality of transportation agreements, the plurality of data objects and sub-objects including one or more calculation sheets and one or more rate tables, provides a plurality of information fields for each of the plurality of transportation agreements and each of the plurality of data objects from the server, the plurality of information fields including information relating to the plurality of transportation agreements, calculation sheets, and rate tables, and provides, in response to a user search, an updatable data entry of at least one data object and sub-object.

### BACKGROUND

Large organizations involved in the transportation of goods may have multiple shipping policies, terms, and/or agreements negotiated by business entities that may apply to a particular shipping route. Each shipping route can be complex. For example, shipping goods from one country to another country may include multiple modes of transport (e.g., ship, air, rail, truck), involve additional taxes, surcharges, and costs than shipping goods within a single country. Different entities in an organization may also negotiate different shipping terms with different customers. A customer with global shipping needs may, for example, negotiate a global rate agreement with the organization's headquarters office for shipping different goods around the world. A local customer who has more limited shipping needs may negotiate a different agreement with a local branch of the organization subject to particular cost constraint specified by headquarters office or others at higher levels of the organization.

Conflicts and related consistency problems have occurred when attempting to calculating freight costs using shipping terms obtained from multiple agreements. In the past, it has been difficult to automatically determine shipping terms and costs in different agreements that may apply to a particular shipping route of a particular good. For example, if two separate agreements both contained different fees relating to a same issue, it was difficult to ascertain which set of fees should be used to calculate the shipping cost.

In the past these issues had been resolved by manually accounting for and resolving every possible conflict scenario between different agreement terms. In addition, even the mere tracking of various agreements also proved challenging. Manual approaches are very cost and labor intensive and may not be practical in situations where there are many different agreements that may apply to a particular shipping route.

Thus, there is a need for an improved system and method for tracking and managing a plurality of transportation agreements.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure. In the drawings:

FIG. 1 illustrates an method for calculating a freight cost for a good according to an example embodiment of the present invention;

FIG. 2 illustrates a representative view of a portable electronic device having a transportation application according to an example embodiment of the present invention;

FIG. 3 illustrates a method for comprehensively copying a transportation agreement according to an example embodiment of the present invention;

FIG. 4 illustrates a method for updating a rate table associated with a transportation agreement according to an example embodiment of the present invention; and

FIG. 5 illustrates a representative view of a backend system according to an example embodiment of the present invention.

### DETAILED DESCRIPTION

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using a device are described. In some embodiments, the device is a portable communication device (e.g., a mobile phone or tablet). The user interface may include a touch screen and/or other input/output devices. In the discussion that follows, a portable communications device is used as an example embodiment. It should be understood, however, that the user interfaces and associated methods may be applied to other devices, such as personal computers and laptops, that may include one or more other physical user-interface devices, such as a keyboard and or mouse.

The portable communication device may support a variety of applications, such as spreadsheet, database, word processor, and transportation applications. The various applications that may be executed on the device may use at least one common physical user-interface device, such as a touch screen. One or more functions of the touch screen as well as corresponding information displayed on the device may be adjusted and/or varied from one application to another and/or within a respective application. In this way, a common physical architecture of the device may support a variety of applications with user interfaces that are intuitive and transparent. In the discussion that follows, a transportation application is used as an example embodiment, but it should be understood that the user interfaces and associated methods may be applied to other applications.

A transportation application that enables users to manage data contained within a plurality of business documents, such as transportation agreements, is provided. For example, freight costs may be calculated by selecting and then simulating shipping costs specified in shipping cost fields in multiple transportation agreement records relating to a shipping route.

The transportation application can be a stand alone application or integrated with enterprise software. In either case, transportation agreements can be stored at a backend server, and accessed by one or more remote terminals, such as a portable electronic device.

In addition, a user may navigate between a plurality of transportation agreements. The plurality of transportation agreements can be categorized and can also be placed in separate work areas corresponding to different geographic locations, calculation sheets, agreement type, agreement dates, or organization. Each of the transportation agreements may have a different calculation method or rate table.

In addition, a user may navigate the transportation application using finger gestures on a touch screen interface to view various work areas and business documents. Alternatively, a user may also navigate the transportation application using more conventional laptop or desktop computers having an Internet browser or standalone application. Irrespective of the interface, a user may view and search transportation agreements. In another example, a user can query the transportation application for agreements that occurred within a specified time range.

In some instances, detailed information may be displayed for a transportation agreement whereas aggregated, consolidated, or more general information can also be displayed. In other instances, different users may have different levels of access to transportation agreements. For example, an employee of an organization may be able to view transportation agreements, but the ability to add new transportation agreements may be restricted to a supervisor.

Each of the agreement records may contain a complete set of shipping charges that are used to calculate the freight cost, though the shipping charges may vary in different agreements. For example, a local city office of an organization may have an agreement or policy to charge customers a local delivery surcharge because of congestion delays, additional local taxes, or extra costs incurred in traveling to particular locations within the local city area. An agreement at the local city office level may include additional shipping charges to account for these surcharges while other agreements need not include these surcharges but may include different charges. The parties, such as the local city office, that may be specified in the party field of the transportation agreement records may represent different regional entities of an organization responsible for different transportation agreement terms.

A state or country division of the organization that encompasses the local city office may also have agreements or policies to charge customers particular rates for transporting goods. For instance, there may be a processing surcharge for deliveries arranged through the state or country division instead of the through the local city office. This additional processing surcharge may be included in agreements at the state or country division level but not at the local city office level. Other entities in the organization may have different cost terms and/or policies that may apply in different situations. There may also be some shipping cost fields, such as a state or country tax field that are included in multiple agreements, such as those at both the state or country level and the local city office level.

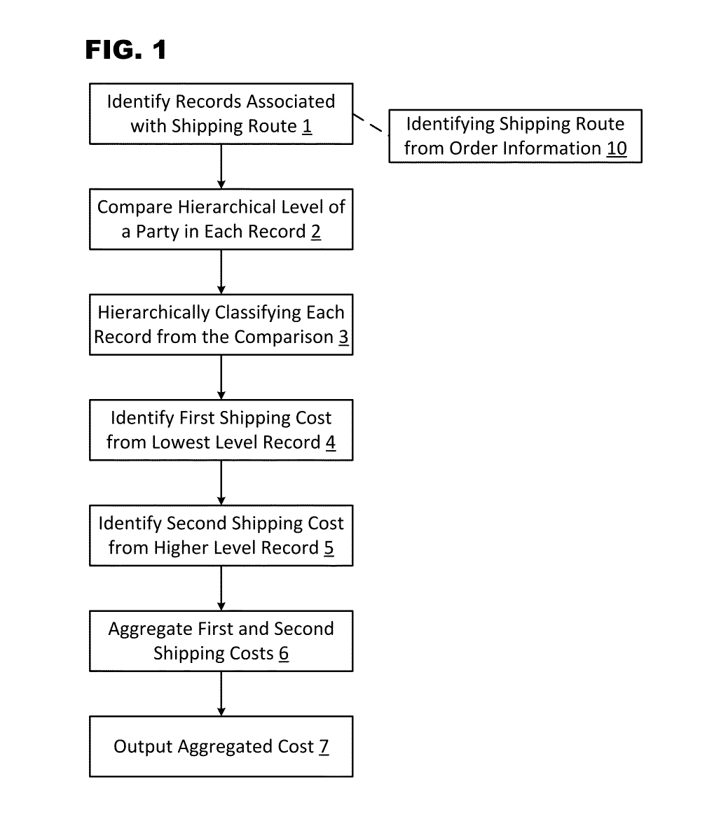

FIG. 1 shows a method for calculating a freight cost for a good according to an example embodiment of the present invention. The process may be performed by a processing device. In some instances, the process may be stored in instructions encoded in a non-transitory computer readable medium, that when executed by the processing device, cause the processing device to perform the process.

At step 1, a plurality of transportation agreement records may be identified that contain data fields specifying shipping costs associated with a shipping route for the good and identifying a party to a transportation agreement. In some instances, a transportation agreement record may include a geographic coverage region data field that specifies at least one location or geographic region to which a transportation agreement cost stored in the shipping cost data field of the transportation agreement record applies. The location information included in the geographic coverage region data field may then compared to the shipping route for the good to determine whether a location specified in the geographic coverage region data field is associated with the shipping route. If the location is not part of the shipping route, then the shipping costs need not be associated with the shipping route. If the location is part of the shipping route, then the shipping costs and the transportation agreement record containing the shipping costs may be associated with the shipping route.

As indicated at sub-step 10, in some instances, a shipping route may be identified from order information included in a sales order object. The sales order object may specify an origin and/or a destination of the good, which may be used to identify the shipping route. In some instances, the shipping route may be automatically determined based on the good and the destination specified in the order information. A known source of the good may be identify and a shipping route may be selected based on the source and destination. In some instances, the transportation agreement records containing a shipping cost data field or other term relating to the source, destination, and/or waypoint of the shipping route may be identified as associated with the shipping route.

Once the transportation agreement records associated with the shipping route have been identified, a relative hierarchical level of a party specified in each of the identified transportation agreement records may be determined. The relative hierarchical level may be determined from an organization chart or other data source indicating a relative ranking of different entities. The other data source may rank parties based on different criteria, such a relative geographical region covered by the parties, a financial size of the parties, or other metric that may be used to rank the parties.

At step 2, a relative hierarchical level of the party in each of the identified transportation agreement records may be compared to that of others in the other agreement records. As one non-limiting example, the comparing of the relative hierarchical level of each of the identified parties may be based on a position of each party in the hierarchical organizational chart. As another non-limiting example, the comparing of the relative hierarchical level of each of the identified parties may be based on a geographic region associated with each party with each party's relative hierarchical level proportional to a size of the geographic region associated with the respective party. Other comparing criteria may be used in different situations depending on the metric that is used to rank to the parties.

As a result of this comparing, at step 3, each of the identified transportation agreement records may be hierarchically classified according to the compared relative hierarchical level of each respective party.

The classified transportation agreement records may then be each analyzed depending on their hierarchical classification. For example, At step 4, the shipping costs may be simulated for each of the agreements.

At step 5, evaluation logic may be applied to each of the simulated shipping costs to determine which of the hierarchical agreements should be used. For example, in some instances the evaluation logic may scan the classified transportation agreement records and identify the agreement record including a particular shipping rate or charge that may be identified as a leading charge type. The agreement records may be filtered to exclude those records that do not identify the particular shipping rate or charge as the leading charge type.

At step 6, the evaluation logic may then select, from any remaining agreement records that were not excluded through the filtering, a final agreement record used to calculate the freight cost for the good. The selection of the final agreement record may be based on the hierarchical classification of the remaining agreement records. In some instances, the evaluation logic may select the agreement record at the lowest hierarchical classification level. In other instances, other selection criteria may be used. For example, the agreement record at a highest or other classification level may be selected or the agreement record having the cheapest or costliest rates may be selected.

At step 7, the calculated freight cost for the good may be output. The outputting of the calculated freight cost may include outputting the freight cost to a memory, register, screen, printer, storage device, or other process or program. Thus, in some instances, the freight cost may be immediately outputted to a display or printer for the user to see, but in other instances the freight cost may be outputted as an input to another program or process, such as a program that calculates a total cost for the user that combines the cost of the good with the calculated freight costs to determine a final total cost.

For example, in some situations, a different entity in an organization may negotiate or provide different fees and/or costs associated with transportation a good. If a global transportation agreement is negotiated between the headquarters office of a company and a customer for worldwide delivery of goods, then the terms of that agreement may apply to all deliveries of that customer and may be included in each of the agreement records. On the other hand, if the local customer negotiates a deal with a local office to transport goods regionally, the negotiated terms of the local customer deal may be different than the global agreement negotiated at the headquarters level and these additional terms may be included in the local agreement records but not in the global agreement records. However, the local office agreement may be constrained by some minimum terms required by headquarters. For example, headquarters may set a minimum delivery fee, may require payment of costs or fees, and so on. These terms may be included in the local agreement records.

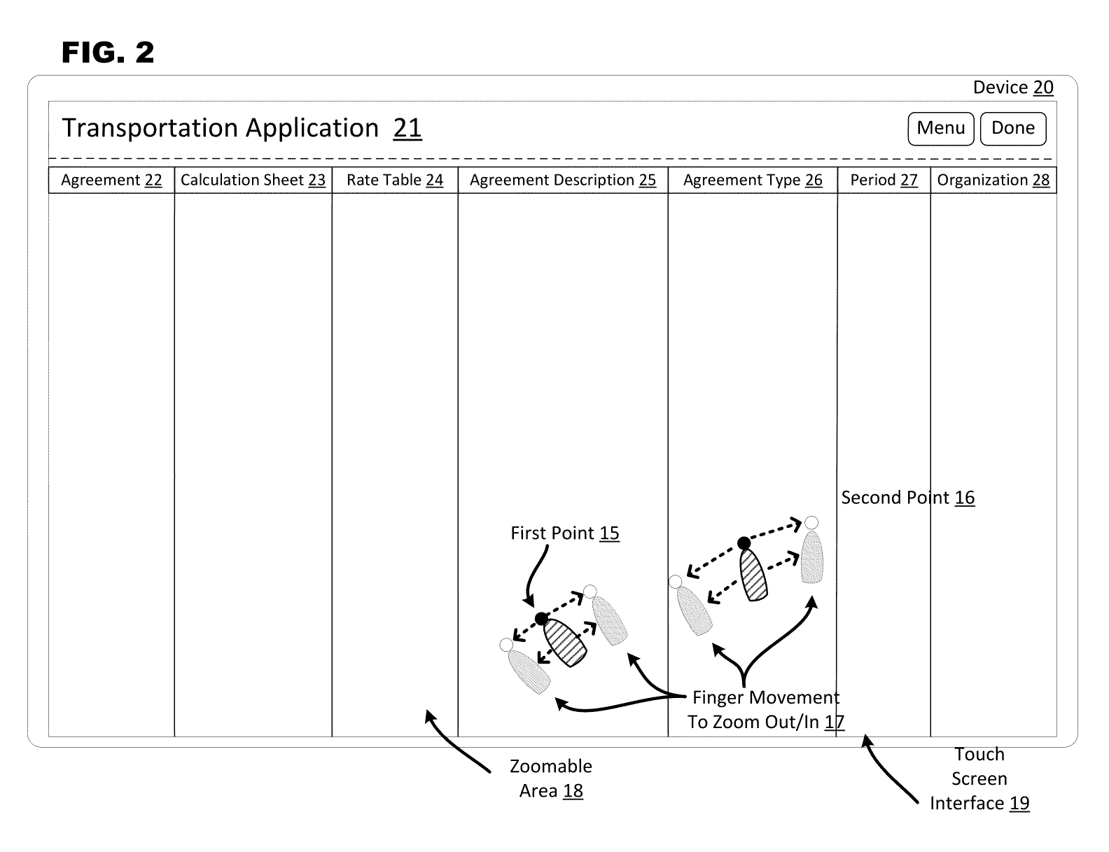

FIG. 2 illustrates a representative view of a portable electronic device having a transportation application according to an example embodiment of the present invention. The depicted example user interface enables a user to manage a plurality of transportation agreements. As shown in FIG. 2, a portable electronic device 20 includes a touch screen interface 19 and transportation application 21 displayed thereon.

The transportation application 21 may use a divided display to illustrate a plurality of transportation agreements 22 and their respective fields including, for example, calculation sheets 23, rate tables 24, agreement descriptions 25, agreement types 26, agreement validity periods 27, and organization or sub-organization 28. The data displayed by transportation application 21 can be extracted from one or more data objects or sub-objects (e.g., local or global data objects). For example, the data displayed by the transportation application 21 can be extracted out of a plurality of global data objects agreements, calculation sheets, rate tables, and scale sheets.

A user, such as a freight contract specialist, logs into the backend system though the transportation application 21 to view one or more transportation agreements 22 and corresponding information accessible through fields 23-28.

One or more transportation agreements may be listed in agreement field 22. The listing of a transportation agreement may include a link to the actual agreement stored within a backend system.

Each transportation agreement 22 can have a corresponding calculation sheet 23. As discussed above, different entities within a large organization may negotiate or provide different fees and/or costs associated with transportation of a good. For example, fees may be calculated based on the source location, destination location, distance, mode(s) of transport (e.g., ship, air, rail, truck), weight, size, or any combination thereof. The calculation sheet field 23 provides a link to a calculation sheet for each agreement. The calculation sheet can then be used to calculate the shipping cost of a particular good.

Each transportation agreement 22 can have a corresponding rate table 24. The rate table 24 is similar to the calculation sheet 23, but also provides the currency and cost amount for each individual calculation used calculate the cost associated with transportation of a good. For example, costs are provided on a per mile basis for each mode of transport. In another example, additional costs may be specified for specific modes of transport, such as a port fee. In yet another example, cost may be specified on a per weight basis or per container basis. In addition, the rate table field 24 provides a link to the rate table for each agreement.

Agreement description field 25 can include additional information, such as any information about the transportation agreement, corresponding tasks, or events associated with a transpiration agreement. For example, if a transportation agreement is set to expire, the agreement description field may be used to track a meeting time with the transport provider.

The agreement type field 26 indicates the type transportation agreement. For example, the transport agreement may be a seasonal agreement or a yearly agreement. In another example, the agreement may be a domestic or international agreement. In yet another example, the agreement may be a single or multimode of transport agreement.

The transportation application 21 also indicates the start and end dates of a transportation agreement within period 27. In addition, the individual or organization that entered the agreement is specified in organization field 28.

The transportation application 21 may include a zoomable area 18 which may encompass the whole display or parts of the display where the user may use their fingers 17 or other objects to zoom in or out of the display. In some instances, information displayed on screen may also be consolidated if the user zooms out of the transportation application 21. The transportation application 21 may also display individual transportation agreements listed in the transportation agreements field 22.

A user may zoom in or out of the divided display by initially selecting first and second points 15 and 16 on the display with their fingers or another object. The user may then drag one or more of their fingers to change the distance between the first point 15 and the second point 16. The change in the distance separating the two points may determine whether to zoom in or out of the document 25 or entries 26 and by what amount.

In some instances, whenever the zoom is readjusted, the entries and/or other content associated with the transportation agreement 22 may also be reassessed for display. For example, the entries 23-28 may be resized according to the zoom level and/or a different number of entries displayed to make the entries more readable and/or selectable by a user.

In some other instances, the transportation application 21 may be searchable. In these instances, selection criteria can include one or more parameters present in the data objects, and can be applied when a user executes a search. In addition, the transportation application 21 may include a divided display having a search area and an information display area. Search results can be displayed in the information area. Search results may produce one or more data entries from a single data object or a plurality of objects and corresponding sub-objects (e.g., local and global rate tables). In other words, a search result table would produce as many records as the number of values in the deepest object.

The transportation application 21 also provides the capability to perform mass updates on data objects. For example, a rate value specified in rate tables selected using the search criteria can be updated at through a single update. In this non-limiting example, all rates from Europe to US can be increased by 5% using the transportation application 21. Rates can be increased by a percentage or by a fixed amount.

As described above, a user may navigate between a plurality of transportation agreements. In the course of business, the plurality of transportation agreements can be categorized and can also be placed in separate work areas corresponding to different types of goods, different organizations, countries, etc. Accordingly, the need may arise for a user to copy a transportation agreement as well as objects and references corresponding to the transportation agreement.

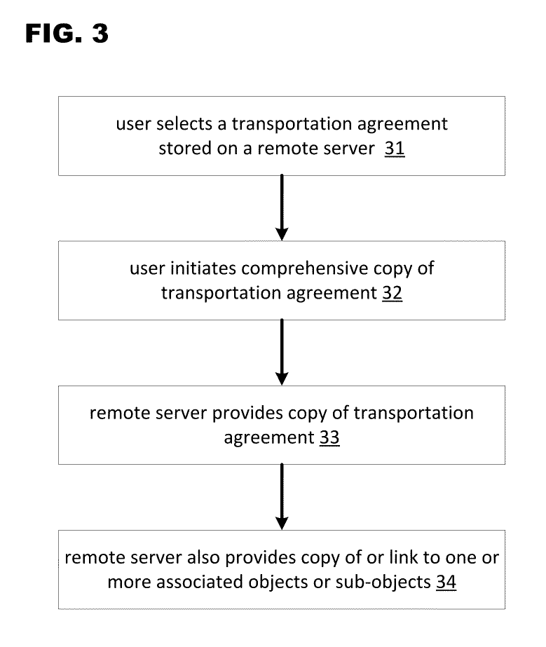

FIG. 3 illustrates a method for comprehensively copying a transportation agreement according to an example embodiment of the present invention.

At step 31, a user identifies a transport agreement, stored on a remote server, that the user desires to copy. The user desires to copy the transportation agreement as well as objects and references associated with the transportation agreement.

At step 32, the user, at a portable electronic device, initiates comprehensive copy of the transportation agreement stored at a remote server. For example, the transportation application can provide a “comprehensive” or “deep” copy button for each transportation agreement. In this manner, the user can initiate the comprehensive copy by selecting a deep copy button displayed in the transportation application of the portable electronic device.

At step 33, the remote server provides a copy of the selected transportation agreement. Next, at step 34, the remote server also provides a copy of associated objects, sub-objects, and relationships between objects. For example, the comprehensive copy can also provide a copy of or link to other objects, such as the corresponding calculation sheet, rate table, agreement description, agreement type, start and end dates, and organization. In other examples, the comprehensive copy may also provide a copy of or link to one or more of the agreement header, preconditions and TCCS objects/references, TCCS items, scale and rate values within rate tables.

Once the comprehensive copy has been completed, a transfer the deep copy of the transportation agreement to a separate work area. In this manner, objects, sub-objects, and relationships between objects associated with the transportation agreement will be transferred to the separate work area.

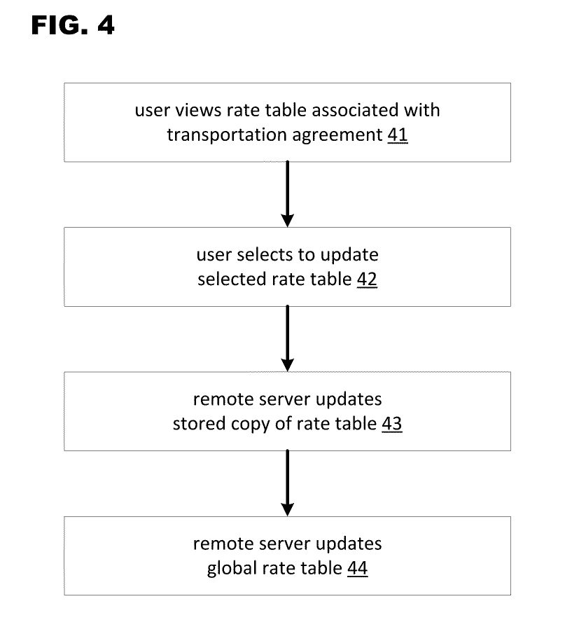

FIG. 4 illustrates a method for updating a rate table associated with a transportation agreement according to an example embodiment of the present invention.

At step 41, a user identifies a transport agreement, stored on a remote server, having a rate table that the user desires to update. Although the user only desires to update the rate table, the backend server will also update a global rate table.

At step 32, the user, at a portable electronic device, initiates a rate table update. For example, the transportation application can provide an “update rate table” button for each transportation agreement. In this manner, the user can initiate the rate table update by selecting a button displayed in the transportation application of the portable electronic device.

Here, the user is provided with a template to update the fields of the rate table. The user can update the source and destination, payment currency, cost entries. For example, a destination of shipping route originating in Mumbai may change from New York to Baltimore. In another example, the cost per unit weight or cost per mile may also be changed.

At step 43, the remote server updates the stored copy of rate table associated with the transportation agreement. At step 44, the remote server also updates a larger global rate table tracking shipping rate costs between a plurality of source and destination points.

Accordingly, if more than one agreement record has shipping cost data related to particular shipping route, the shipping costs of multiple transportation agreements can be tracked and compared so the costs can be reduced.

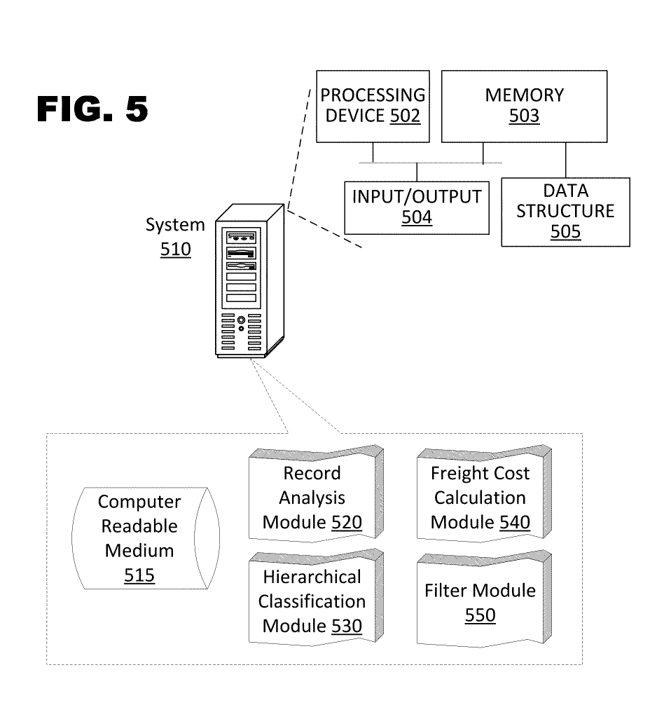

FIG. 5 illustrates a representative view of a backend system according to an example embodiment of the present invention.

Backend system 510, such as a server, may include a computer readable medium 515 storing application modules that may include a record analysis module 520, hierarchical classification module 530, freight cost calculation module 540, and/or filter module 550. In some instances, modules 520 to 550, and/or other modules or components of the system 510 may be stored in a memory 503 or data structure 505 that is separate from the computer readable medium 515 and/or the system 510. System 510 may also include a processing device 502, memory 503 storing loaded data or a loaded data structure 505, and an input/output interface 504, all of which may be interconnected via a system bus.

The record analysis module 520 may include functionality for identifying, in some instance through or using the processing device 502, a plurality of transportation agreement records containing data fields specifying shipping costs associated with a shipping route for a good and identifying a party to a transportation agreement. The record analysis module 520 may also including functionality for associating a transportation agreement record with the shipping route when a geographic coverage region specified in the respective transportation agreement record includes at least one location that is part of the shipping route. The record analysis module 520 may also identify the shipping route from at least one of an origin and a destination of the good specified in the sales order object.

The hierarchical classification module 530 may include functionality for comparing a relative hierarchical level of the party in each of the identified transportation agreement records and hierarchically classifying each of the identified transportation agreement records according to the compared relative hierarchical level of each respective party. The hierarchical classification module 530 may compares the relative hierarchical level of each of the identified parties based on a geographic region associated with each party with each party's relative hierarchical level proportional to a size of the geographic region associated with the respective party. The hierarchical classification module 530 may compare the relative hierarchical level of each of the identified parties based on a position of each party on a hierarchical organizational chart.

The freight cost calculation module 540 may include functionality for simulating total shipping costs associated with the shipping route based on data in at least one of the shipping cost data fields of at least one of the classified transportation agreement records and calculating the freight cost from data in at least one of the shipping cost data fields in a remaining transportation agreement record classified at a lowest hierarchical level after the filtering.

The filter module 550 may include functionality for filtering out those classified transportation agreement records that are not identified as leading charge types based on a leading charge type indicator associated with each of the classified transportation agreement records.

The output interface 504 may include an interface for outputting the calculated freight cost for the good to an output device. The output device may include a memory, a display screen, a printer, or a computing device. The output interface 504 may enable communications between the system 510 and the output device connected to the interface 504.

System 510 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 503 may contain different components for retrieving, presenting, changing, and saving data and may include the computer readable medium 515. Memory 503 may include a variety of memory devices, for example, Dynamic Random Access Memory (DRAM), Static RAM (SRAM), flash memory, cache memory, and other memory devices. Additionally, for example, memory 503 and processing device(s) 502 may be distributed across several different computers that collectively comprise a system.

Processing device 502 may perform computation and control functions of a system and comprises a suitable central processing unit (CPU). Processing device 502 may include a single integrated circuit, such as a microprocessing device, or may include any suitable number of integrated circuit devices and/or circuit boards working in cooperation to accomplish the functions of a processing device. Processing device 502 may execute computer programs, such as object-oriented computer programs, within memory 503.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, although the system 510 is shown as a single integrated system, in some instances the functionality in system 510 may be distributed over two or more systems that are configured to appear as a functionally integrated single system.

1. A method comprising:
storing a plurality of transportation agreements;
associating a plurality of data objects and sub-objects with each of the plurality of transportation agreements;
providing a plurality of information fields for each of the plurality of transportation agreements and each of the plurality of data objects;
providing the plurality of information fields for display; and
providing, in response to a user search, an updateable data entry of at least one data object and sub-object.

2. The method of claim 1, wherein the plurality of information fields includes information relating to transportation agreements, calculations, and rate tables.

3. The method of claim 1, wherein the plurality of information fields includes links to transportation agreements, calculation sheets, and rate tables.

4. The method of claim 1, wherein the plurality of information fields are simultaneously displayed on a divided screen.

5. The method of claim 1, further comprising providing one of the plurality of transportation agreements or one of the plurality of data objects or sub-objects for display.

6. A server comprising:
one or more process; and
memory storing one or more programs for execution by the one or more process, the one or more programs including instructions for:
storing a plurality of transportation agreements;
associating a plurality of data objects or sub-objects with each of the plurality of transportation agreements;
providing a plurality of information fields for each of the plurality of transportation agreements and each of the plurality of data objects from the server;
providing the plurality of information fields for display; and
providing, in response to a user search, an updateable data entry of at least one data object and sub-object.

7. The server of claim 6, wherein the plurality of information fields includes information relating to transportation agreements, calculations, and rate tables.

8. The server of claim 6, wherein the plurality of information fields includes links to transportation agreements, calculation sheets, and rate tables.

9. The server of claim 6, wherein the plurality of information fields are simultaneously displayed on a divided screen.

10. The server of claim 6, further comprising instructions for providing one of the plurality of transportation agreements or one of the plurality of data objects or sub-objects for display.

11. A non-transitory computer readable storage medium storing one or more programs configured to be executed by a processor, the one or more programs comprising instructions for:
storing a plurality of transportation agreements;
associating a plurality of data objects and sub-objects with each of the plurality of transportation agreements;
providing a plurality of information fields for each of the plurality of transportation agreements and each of the plurality of data objects from the server;
providing the plurality of information fields for display; and
providing, in response to a user search, an updatable data entry of at least one data object and sub-object.

12. The non-transitory computer readable storage medium of claim 11, wherein the plurality of information fields includes information relating to transportation agreements, calculations, and rate tables.

13. The non-transitory computer readable storage medium of claim 11, wherein the plurality of information fields includes links to transportation agreements, calculation sheets, and rate tables.

14. The non-transitory computer readable storage medium of claim 11, wherein the plurality of information fields are simultaneously displayed on a divided screen.

15. The non-transitory computer readable storage medium of claim 11, further comprising instructions for providing one of the plurality of transportation agreements or one of the plurality of data objects or sub-objects for display.

16. A server comprising:
one or more process; and
memory storing one or more programs for execution by the one or more process, the one or more programs including instructions for:
storing a plurality of transportation agreements;
associating a plurality of data objects and sub-objects with each of the plurality of transportation agreements, the plurality of data objects and sub-objects including one or more calculation sheets and one or more rate tables;
providing a plurality of information fields for each of the plurality of transportation agreements and each of the plurality of data objects from the server, the plurality of information fields including information relating to the plurality of transportation agreements, calculation sheets, and rate tables; and
providing, in response to a user search, an updatable data entry of at least one data object and sub-object.
